(19) United States
(12) Patent Application Publication
(10) Pub. No.: US 2004/0069924 A1
(43) Pub. Date: Apr. 15, 2004

(54) Resilient floor surface

(76) Inventors: Alain Lemieux, Sherbrooke (CA); Seymour Tomarin, St Catherines (CA)

Correspondence Address: HARNESS, DICKEY & PIERCE, P.L.C., P.O. BOX 828, BLOOMFIELD HILLS, MI, 48303, US

(21) Appl. No.: 10/466,040

(22) PCT Filed: Jan. 15, 2001
(86) PCT No.: PCT/CA01/00035

(51) Int. Cl. F16M 13/00

(52) U.S. Cl. 248/633

(57) ABSTRACT

A resilient floor surface for indoor and outdoor, residential, commercial and sporting applications includes a resilient underpad formed of expanded polypropylene product (“EPP”) and suitable for being laid down directly on the ground or other subfloor surface in a floating arrangement not requiring securing to the ground or other subfloor surface, and a floor covering material applied upon the resilient underpad as a covering for the resilient underpad. The surface covering is of the type suitable for floor surfacings, sport playing surfacings and decorative and sports surface coatings, and is selected from hardwood flooring, synthetic rubber and/or plastic flooring tiles and panels, rubber flooring tiles and panels, laminated wood flooring, residential and commercial carpets, crumb rubber surface coatings, EPDM (ethylene-propylene terpolymer) surface coatings, polyurethane surface coatings and any other suitable coatings. The resulting floor surface is shock-absorbing, sound and heat insulating, waterproof, lightweight, and durable, and is less expensive and easier to install than other flooring systems, due to the elimination of the multiple components required in prior flooring systems.

### TECHNICAL FIELD

This invention relates to an improved synthetic flooring surface for use in indoor and outdoor applications.

### BACKGROUND OF INVENTION

Typical flooring materials for both indoor and outdoor applications are natural and synthetic materials that can commonly be found and processed or manufactured inexpensively. Such materials have a wide variety of both general and specific applications, some of which favor special properties of the material. Some of the special properties of such materials deal with the amount of weight which a surface can bear, its workability, durability, resiliency, shock absorbency, compressive properties and energy dissipation and return upon contact, sound and temperature insulation, feel or abrasiveness upon contact, slip or rolling resistance, porosity, water, weather and chemical resistance, ease of maintenance, flammability resistance, environmental friendliness and allergen and toxicity concerns.

Common applications for flooring materials include residential and commercial flooring surfaces upon the ground and within multi-level building structures, rooftop plazas, sports and playground specialty surfaces and decorative or comfort coverings and surfaces. These include multi-purpose synthetic gymnasium flooring, hardwood gymnasium flooring, synthetic tennis courts, backyard synthetic game courts, safety playground areas for children, pool, sidewalk and other recreational areas, residential and commercial hardwood and laminated wood floor surfacings, commercial high traffic synthetic and rubber floor surfacings, residential and commercial carpet and carpet cushion floor surfacings and rooftop materials. Specific examples of common residential and commercial floor coverings include hardwood and carpet floorings, rubber tiles and panels, synthetic rubber tiles and panels, synthetic plastic tiles and panels, laminated floating wood floor surfaces, polyurethane coating floor coverings and EPDM (ethylene-propylene terpolymer) surfacing and crumb rubber coatings used for playground areas.

One goal of using many of these various materials is to build a suitable flooring surface that is cushion-absorbent, that is, one that is soft, makes the floor comfortable underfoot, protects against falling down injuries and maintains playability. This is especially applicable for sporting surfaces, such as basketball, racquetball and tennis courts and running tracks, but is also relevant to general walking comfort within any building. Another primary aim is to provide a material that insulates against sound and heat transmission. In this way, the flooring material can minimize noise between floors of a multi-level structure and insulate against heat loss to the surrounding ground or air. Yet another focus is its manner of installation, with “suspended” or “floating” flooring surfaces offering the advantage of not requiring nailing or gluing to the subfloor or other underlying surface. Any material which includes these desirable features must also be suitably durable for sufficient life, must be inexpensive enough to be commonly used and must be easy to install and maintain. Many flooring materials are typically provided in sheet, panel, slab or roll form for ease of installation and maintenance.

Many current flooring materials have several deficiencies in one or more properties which make them undesirable. In the case of many hardwood and synthetic flooring materials, they may lack the resilience or shock-absorbence that would make the material more comfortable for walking or sports play. They may also require various types of complex subfloor arrangements for support, such as special frames or beams and may not be able to hide minor irregularities in the subfloor material. In addition, current floorings may have to be secured to the ground or subfloor arrangement in a time-consuming and costly manner, which can be disadvantageous for both installation and later removal for replacement, maintenance or floor switching purposes (such as for alternate sporting events in a single location). Other floorings simply fail to be sufficiently waterproof to be installed directly upon the ground or in other applications where waterproofing is required. In yet other arrangements, multiple materials are used in a sequential, layered or underpadding arrangement in a costly and time-consuming attempt to obtain combinations of advantages from the properties of each of the individual material components. Examples of such materials include recycled automobile tires, crumb rubber product, sponge rubber, fibre cushion and resilient polyurethane foam. Layered materials must sometimes be secured together through the use of polyurethane glues or other adhesives, adding to the time and cost of installation.

Thus, there is a need for an improved flooring material having the combined desired properties of sound and heat insulation, moisture barrier or full waterproofing and shock-absorbence, which avoids the need for numerous materials used either sequentially or in other combinations, which is easy and forgiving to use and maintain, and which avoids the time and cost associated with complex installation. The large variety of materials present in the art demonstrate that that such a desirable flooring surface had not been found.

### SUMMARY OF THE INVENTION

The present invention contemplates a resilient floor surface utilizing expanded beads of polypropylene (also known as expanded polypropylene product, or “EPP”) in panel, slab or sheet form in varying convenient dimensions and densities as a resilient underpad laid down directly on the ground or other base or subfloor surface. The underpad may optionally be covered by any suitable floor surfacing (such as hardwood, laminated wood, commercial and residential carpet, plastic, rubber or synthetic rubber tiles), sport playing surfacing (such as gymnasium hardwood, plastic and/or synthetic rubber tiles and panels) or decorative and sports surface coating, such as a crumb rubber surface coating, an EPDM (ethylene-propylene terpolymer) surface coating, a polyurethane surface coating or other suitable coating. EPP was originally designed and used for several years as a shock-absorbent material in the automobile and packaging industries, in head protection helmets and to enhance flotation in the marine industry. However, to the best of the inventor's knowledge, this material has never been applied for the flooring industry as an underpad in panel, slab or sheet form. The material can also be used as a roofing membrane, in combination with a suitable outdoor resistant floor covering material.

The EPP material may be used in any desired hand-portable panel, slab or sheet dimensions, including 4-foot by afoot (120 cm by 180 cm), the 4-foot by 8-foot (120 cm by 240 cm) configuration common to standard plywood sheets or in rolls of desired width, such as 12-feet (3.6 m), 16-feet (4.8 m), 20-feet (6.0 m) or 24-feet (7.2 m), by any desired length. It may be provided in convenient thicknesses such as about ⅛-inch to 12 inches (3 mm to 30.5 cm). The invention contemplates utilizing expanded beads of polypropylene of a density of approximately between about 1.1 to 2.8 pounds per cubic foot (0.018 grams per cubic cm to 0.045 grams per cubic cm) molded into a sheet or pad of open cell structure with a density of between about 1.1 to 3.5 pounds per cubic foot (0.018 grams per cubic cm to 0.056 grams per cubic cm). The floor surface covering may be provided in thicknesses between about ⅛-inch to 4 inches (3 mm to 102 mm).

A method for installing the resilient floor surface includes providing hand-portable panels, slabs or sheets of the EPP material underpad, cutting them to the desired configurations, and installing them directly upon the ground or other base or subfloor support surface, preferably without securing the underpad material to the support surface. The underpad is then covered with any suitable floor surfacing, sport playing surfacing or decorative and sports surface coating by spraying, brushing, spreading or other suitable application activity.

Thus, an object of this invention is to provide a resilient underpad material for a flooring surface formed of open cell, molded, expanded bead polypropylene which is cost effective, easy to install and maintain, waterproof or water resistant, sound and heat insulated and which avoids the time and cost associated with complex installation of prior combinations of materials.

These and other objects and advantages of this invention will become apparent upon reading the following description, of which the attached drawing forms a part.

### DESCRIPTION OF DRAWING

FIG. 1 is a cross-sectional view of a resilient, molded open cell, expanded bead polypropylene underpad, with a surface covering disposed thereupon.

### DETAILED DESCRIPTION

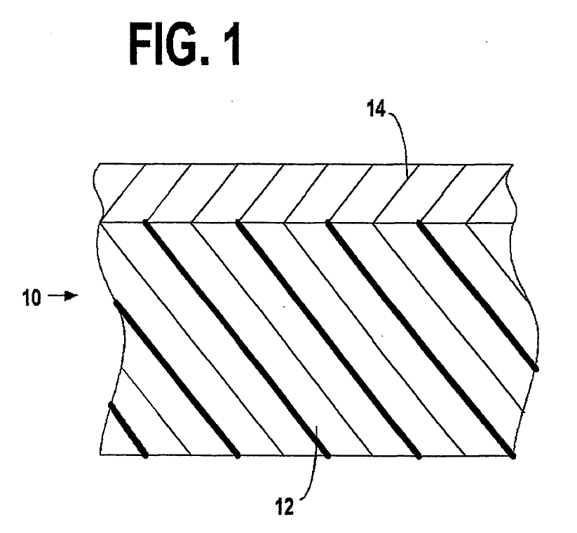

Referring to FIG. 1, there is shown a cross-sectional view of resilient floor surface of the present invention, generally at 10. The resilient floor surface 10 includes a resilient, molded open cell, expanded bead polypropylene (EPP) underpad 12, which may preferably be provided in hand-portable panel, slab or sheet form. The EPP material tends to be resilient, i.e., shock-absorbing, non-porous, i.e., waterproof and insulating with respect to both sound and heat transmission. Depending upon the particular use application and the surface upon which the resilient floor surface is to be applied, the EPP underpad 12 may be of any desired thickness. Typical thicknesses for the EPP underpad 12 will be from about ⅛-inch to 12 inches (3 mm to 30.5 cm). In most applications, however, preferred thicknesses will be from about ½-inch to 4 inches (13 mm to 102 mm). Panels, slabs or sheets of the EPP underpad 12 may also be provided in any desired dimensions favoring transportation and workability, including a 4-foot by 6-foot (120 cm by 180 cm) configuration, the 4-foot by 8-foot (120 cm by 240 cm) configuration common to standard plywood sheets and rolls of desired width, such as 12-feet (3.6 m), 16-feet (4.8 m), 20-feet (6.0 m) or 24-feet (7.2 m), by any desired length. The expanded beads of polypropylene making up the EPP underpad 12 are typically of a density of approximately between about 1.1 to 2.8 pounds per cubic foot (0.018 grams per cubic cm to 0.045 grams per cubic cm), and are molded into a sheet or pad of open cell structure with a density of between about 1.1 to 3.5 pounds per cubic foot (0.018 grams per cubic cm to 0.056 grams per cubic cm).

The resilient floor surface 10 is also shown to include a surface covering 14 disposed atop the EPP underpad 12, for use as a suitable floor surfacing, sport playing surfacing or decorative surface coating. The surface covering 14 may be of any material desired for the particular application. Preferred material selections for the surface covering 14 include, but are not limited to, hardwood flooring, synthetic rubber and/or plastic flooring tiles and panels, rubber flooring tiles and panels, laminated wood flooring, residential and commercial carpets, and surface coating including crumb rubber surface coating, an EPDM (ethylene-propylene terpolymer) surface coating or a polyurethane surface coating. Preferred thicknesses for the surface covering 14 range from about ⅜-inch to 1 inch (9 mm to 2.6 cm), although any suitable thickness may be used. In applications where extra shock-absorbence is desired, a thicker surface covering 14 such as an EPDM coating for a playground may be used. The surface covering 14 may also be enhanced with any suitable coloring or texture additives to enhance the surface appearance and/or performance.

The resilient floor surface 10 of the present invention may be laid down easily over any type of ground floor or base or underlying support system including compacted sand, earth, asphalt, concrete slab, wood joists, plywood, ceramic, terrazo floor and other subsurfaces. It also is able to hide irregularities in the underlying surface, resulting in convenient installation. The lightweight construction of the EPP underpad 12 results in manageable panels, slabs or sheets weighing from about 2.5 to 4 pounds (1.1 kg to 1.8 kg) for a 4-foot by 6-foot sheet (120 cm by 180 cm) of 1 inch (2.54 cm) thickness. This may reduce the time and effort required for installation and may reduce the amount of subfloor structure otherwise required to support multiple flooring components of greater weight. The combined properties of resilience or shock-absorbence, sound and heat insulation, moisture barrier and full waterproofing make the resilient floor surface 10 a preferred energy, time and cost-saving choice for many flooring applications, including those such as over concrete subfloors or directly upon the earth. The non-porous nature of the EPP underlay material allows a synthetic covering of the types described herein to be conveniently directly fixed upon it. The convenience of transportation and installation, combined with the above properties, make the resilient floor surface 10 a suitable lower cost replacement having fewer components, less thickness, less weight and improved performance over prior multi-component flooring systems.

Examples of suitable uses for the resilient floor surface 10 of the present invention cover both indoor and outdoor applications including residential and commercial flooring surfaces upon the ground and within multilevel building structures, rooftop plazas, sports and playground specialty surfaces and decorative or comfort coverings and surfaces. The invention especially contemplates this flooring surface for use on sporting surfaces, such as basketball, racquetball, squash, tennis and other game and court surfaces and running tracks, safety playground areas for children, pool, sidewalk and other recreational areas, as well as for general walking surfaces within any building and rooftop plaza or game surfaces. It is believed that this flooring surface provides general comfort for walking and resilience for safety in sports play. Specifically, the resilience of the floor surface 10 can be adjusted as desired to provide a high performance in cushioning and shock absorbence, skeletal and muscular trauma protection, the reduction of fatigue-inducing vertical impact shock and energy return for competitive sports play. The cushion properties of the EPP panel provide absorption of up to 90% of the impact of foot traffic as an anti-fatigue floor surfacing and could add up to 50% to the lifespan of the covering material 14 by reducing friction. In addition, the EPP underpad material has high resistant and compressive properties, such that it tends not to compact or break down during its lifetime as do some other flooring components. Upon contact, the EPP underpad material tends to return back to its original shape without permanent deformation. The resilient floor surface 10 of the present invention is believed to be environmentally friendly and recyclable, non-allergenic and non-toxic, meets or exceeds all applicable flammability standards and is resistant to breakdown from contact with moisture and most chemicals.

In the method of installing a resilient floor surface 10 of the present invention, panels, slabs, sheets or rolls of the EPP underpad 12 are brought to the installation site. The panels, slabs or sheets are arranged in neighboring fashion, edge-to-edge, with interlocking edge or “key” sections, and may be laid in place in a “suspended” or “floating” manner directly upon the ground or other subfloor support surface. The rolls are also spread in place in a “suspended” or “floating” manner directly upon the ground or other subfloor support surface. They may also be cut where needed to any desired custom dimensions for the surface to be formed, such as at the perimeter of the surface against walls or around obstructions. As an advantage over prior flooring systems, it is not necessary that the EPP underpad 12 be nailed, glued or otherwise secured to the subfloor or other underlying support surface. This aids in later maintenance and removal of the resilient floor surface 10 for replacement or periodic floor surface switching which can accompany multiple sporting events being held in a single venue. The underpad 12 is then covered with a suitable floor surfacing, sport playing surfacing or decorative surface covering 14 of the types and in the thicknesses mentioned herein by spraying, brushing, spreading or other suitable application activity. Optionally, such as in areas where waterproofing is not an issue, the surface covering 14 may be applied up to and coinciding with the edges of the panels, slabs or sheets of the underpad 12, so that removable and replaceable panels are created for the resilient floor surface 10 as a whole.

### SPECIFIC EXAMPLE 1

A resilient gymnasium floor surface is installed by providing multiple rolls of a resilient underpad material of 1-inch (24 mm) thickness, formed of expanded polypropylene product (EPP), in 16-foot (4.8 m) width. The rolls are spread directly over the existing concrete gymnasium subfloor surface in a floating arrangement and are cut to the desired gymnasium floor surface size. The edges of the spread underpad material are interlocked with each other to form a continuous resilient underpad for the entire gymnasium floor. A laminated wood floor covering material of 1-inch (2.6 cm) thickness, provided in square configuration, is then applied in interlocking manner over the resilient underpad as a covering for the resilient underpad to form the gymnasium playing surface.

It will be appreciated that this invention may be further developed within the scope of the following claims. Accordingly, it is desired that the foregoing description be read as being merely illustrative of an operative embodiment of this invention and not in a strictly limiting sense.

1. A resilient floor surface comprising:
a resilient underpad formed of expanded polypropylene product (“EPP”) and suitable for being laid down directly on the ground or other base or subfloor surface in a floating arrangement not requiring securing to the ground or other subfloor surface; and
a floor surface covering material applied upon the resilient underpad as a covering for the resilient underpad.

2. The resilient floor surface of claim 1, wherein the resilient underpad formed of expanded polypropylene product (“EPP”) is provided in the form of a plurality of hand-portable panels, assembled in an edge-to-edge arrangement over a desired area.

3. The resilient floor surface of claim 2, wherein the portable panels include an interlocking edge arrangement for securing adjacent panels edges with respect to each other.

4. The resilient floor surface of claim 2, wherein the resilient underpad formed of expanded polypropylene product (“EPP”) is provided in configurations selected from the group consisting of 4-foot by 6-foot (120 cm by 180 cm) and 4-foot by 8-foot (120 cm by 240 cm) configurations.

5. The resilient floor surface of claim 1, wherein the resilient underpad formed of expanded polypropylene product (PEPPY is provided in the form of a roll suitable for being spread over a desired area.

6. The resilient floor surface of claim 5, wherein the roll is provided in widths selected from the group consisting of 12-feet (3.6 m), 16-feet (4.8 m), 20-feet (6.0 m) and 24-feet (7.2 m).

7. The resilient floor surface of claim 1, wherein the resilient underpad formed of expanded polypropylene product (“EPP”) is of a thickness of about ⅛-inch to 12 inches (3 mm to 30.5 cm).

8. The resilient floor surface of claim 1, wherein the resilient underpad formed of expanded polypropylene product (“EPP”) is of a thickness of from about ½-inch to 4 inches (13 mm to 102 mm).

9. The resilient floor surface of claim 1, wherein the resilient underpad formed of expanded polypropylene product (“EPP”) is of a density of approximately between about 1.1 to 2.8 pounds per cubic foot (0.018 grams per cubic cm to 0.045 grams per cubic cm).

10. The resilient floor surface of claim 1, wherein the resilient underpad formed of expanded polypropylene product (“EPP”) is molded into a sheet or pad of open cell structure with a density of between about 1.1 to 3.5 pounds per cubic foot (0.018 grams per cubic cm to 0.056 grams per cubic cm).

11. The resilient floor surface of claim 1, wherein the surface covering is selected from the group consisting of floor surfacings, sport playing surfacings and decorative and sports surface coating.

12. The resilient floor surface of claim 1, wherein the surface covering is selected from the group consisting of hardwood flooring, synthetic rubber and/or plastic flooring tiles and panels, rubber flooring tiles and panels, laminated wood flooring, residential and commercial carpets, crumb rubber surface coating, EPDM (ethylene-propylene terpolymer) surface coating and polyurethane surface coating.

13. The resilient floor surface of claim 1, wherein the surface covering is of a thickness of about ⅛-inch to 4 inches (3 mm to 102 mm).

14. The resilient floor surface of claim 1, wherein the surface covering is enhanced with a coloring or texture additive to enhance the surface appearance and/or performance of the resilient floor surface.

15. The resilient floor surface of claim 1, wherein the resilient floor surface is suitable for both indoor and outdoor applications.

16. The resilient floor surface of claim 1, wherein the resilient floor surface is suitable for uses selected from the group consisting of residential and commercial flooring surfaces upon the ground and within multi-level building structures, rooftop membrane systems, sports and playground specialty surfaces, decorative surfaces, comfort surfaces, basketball, racquetball, squash and tennis and court surfaces, running tracks, safety playground areas for children, pool, sidewalk and other recreational areas, general walking surfaces within any building and roof plaza and game surfaces.

17. The resilient floor surface of claim 1, wherein the resilient floor surface is removable and replaceable.

18. A resilient floor surface comprising:
a plurality of hand-portable panels formed of expanded polypropylene product (“EPP”) assembled in an interlocking edge-to-edge arrangement over a desired area in a floating arrangement not requiring securing to the ground or other subfloor surface; and
a surface covering material applied upon the resilient underpad as a covering for the resilient underpad, selected from the group consisting of hardwood flooring, synthetic rubber and/or plastic flooring tiles and panels, rubber flooring tiles and panels, laminated wood flooring, residential and commercial carpets, crumb rubber surface coating, EPDM (ethylene-propylene terpolymer) surface coating and polyurethane surface coating.

19. The resilient floor surface of claim 18, wherein the surface covering is applied over adjoining edges of the plurality of hand-portable panels formed of expanded polypropylene product (“EPP”) so as to form a continuous exposed surface.

20. The resilient floor surface of claim 18, wherein the surface covering is applied up to, but not over, the edges of the plurality of hand-portable panels formed of expanded polypropylene product ( “EPP”), so as to form a plurality of removable floor surface units.

21. A method for installing a resilient floor surface comprising the steps of:
providing a plurality of hand-portable resilient underpad panels formed of expanded polypropylene product (“EPP”);
arranging the plurality of hand-portable resilient underpad panels in an edge-to-edge arrangement directly on the ground or other subfloor surface in a floating arrangement not requiring securing to the ground or other subfloor surface; and
applying a floor covering material upon the resilient underpad as a covering for the resilient underpad.

22. The method for installing a resilient floor surface of claim 21, further comprising the step of securing adjacent underpad panels with respect to each other by interlocking adjacent panel edges.

23. The method for installing a resilient floor surface of claim 21, wherein the step of applying a floor covering material upon the resilient underpad includes applying the covering material over adjoining edges of the plurality of hand-portable panels formed of expanded polypropylene product (“EPP”) so as to form a continuous exposed surface.

24. The method for installing a resilient floor surface of claim 21, wherein the step of applying a floor surface covering upon the resilient underpad includes applying the covering material up to, but not over, the edges of the plurality of hand-portable panels formed of expanded polypropylene product (“EPP”), so as to form a plurality of removable floor surface units.

25. A method for installing a resilient floor surface comprising the steps of:
providing a resilient underpad panel formed of expanded polypropylene product (“EPP”) in roll form;
spreading the resilient underpad panel roll directly on the ground or other subfloor surface in a floating arrangement not requiring securing to the ground or other subfloor surface; and
applying a floor covering material upon the resilient underpad as a covering for the resilient underpad.
